(19) United States
(12) Patent Application Publication
(10) Pub. No.: US 2023/0322109 A1
(43) Pub. Date: Oct. 12, 2023

(54) ANCILLARY ELECTRIC VEHICLE OR FUEL CELL ELECTRIC VEHICLE CHARGING AND REFUELING

(71) Applicant: Ohmium International, Inc., Incline Village, NV (US)

(72) Inventors: Arne Ballantine, Lugano (CH); Rasool Aghatehrani, Redwood City, CA (US); Chockkalingam Karuppaiah, Fremont, CA (US); Celeste Mueller, Boston, MA (US); Frederick Paul Freeland, JR., Port Orchard, WA (US)

(21) Appl. No.: 18/131,672

(22) Filed: Apr. 6, 2023

Related U.S. Application Data
(60) Provisional application No. 63/328,891, filed on Apr. 8, 2022.
(60) Provisional application No. 63/332,170, filed on Apr. 18, 2022.

(51) Int. Cl. B60L 53/54; H01M 16/00; B60L 58/30

(52) U.S. Cl. CPC B60L 53/54; H01M 16/003; B60L 58/30; B60L 2210/10

(57) ABSTRACT

The systems and methods described herein provide high-precision control of hydrogen generation and electricity use, thereby increasing the efficiency of the overall process. The system may include a power source that includes a rectifier for converting an alternating current input power signal to a direct current power signal. The direct current power signal may also be converted to a voltage level through a converter as an output to a vehicle network. A hydrogen generating system may also produce and provide hydrogen to the vehicle network. In some implementations, the vehicle network may include one or more electrical vehicles, hydrogen fuel-based vehicles, or hybrid hydrogen/electrical vehicles.

### CROSS-REFERENCE TO RELATED APPLICATIONS

This application claims the benefit of U.S. Provisional Application No. 63/328,891, filed on Apr. 8, 2022, and U.S. Provisional Application No. 63/332,170, filed on Apr. 18, 2022, the entire contents of which are incorporated herein by reference.

### FIELD OF THE DISCLOSURE

The present disclosure is generally related to charging or refueling electric vehicles or fuel cell electric vehicles through a hydrogen generation system.

### BACKGROUND

Electrolysis (i.e., in the context of clean carbon production in the form of hydrogen) is a rapidly growing and enabling technology that provides a preferable and sustainable alternative to fossil fuels and the resulting environmentally harmful CO2 emissions. Electrolysis may be described as the process of using electricity to split water into hydrogen and oxygen, with this reaction taking place in a unit called an “electrolyzer.”

Through electrolysis, the electrolyzer system creates hydrogen gas which may be used as an energy source, such as in hydrogen-powered vehicles. The leftover oxygen is released into the atmosphere or can be captured or stored to supply other industrial processes or even medical gases in some cases. The hydrogen gas can either be stored as a compressed gas or liquefied, and since hydrogen is an energy carrier, it can be used to power any hydrogen fuel cell electric application, whether it's trains, buses, trucks, or data centers. The commercial interest in hydrogen fuel (commonly referred to as the fuel cell) is increasing due to the amount of heat that is produced during the electrochemical process.

During this process, hydrogen atoms react with oxygen atoms to form water during oxidation; electrons are released in the process and flow as an electric current through an external circuit. Hydrogen fuel uses the chemical energy of hydrogen to produce electricity as a clean form of energy, with electricity, heat, and water vapor being the only products and byproducts. This process produces zero carbon dioxide, a critical key to reducing greenhouse emissions. Hydrogen fuel cells offer a variety of applications, providing power for automobiles, aircraft, seagoing vessels, and emergency backup power supplies. Hydrogen fuel has additional uses for large stationary (industrial) as well as mobile/portable (personal) applications.

Currently, hydrogen generation for refueling a fuel cell of a vehicle is provided by a system separate from a system used to recharge a battery of the vehicle. In general, power or energy provided to hydrogen generation systems are typically used solely for the hydrogen generation. Thus, refueling and recharging stations often employ separate systems to charge a hydrogen and/or electrical vehicle. The use of two separate systems reduces the efficient use of capital and input energy, particularly in systems that may use renewable energy sources for powering the hydrogen generation system, such as an electrolyzer.

### SUMMARY

According to one embodiment, an ancillary electric vehicle or fuel cell electric vehicle charging and refueling includes a hydrogen generation system in communication with an input power source. The hydrogen generation system may include an electrochemical stack producing hydrogen, a power source receiving an input power signal from the input power source and in electrical communication with an electric vehicle network and the electrochemical stack, and a controller comprising a processor and a non-transitory computer-readable medium encoded with instructions. When executed by the processing device, the instructions cause the processing device to receive a request for an output power signal comprising a requested power level and control the power source to convert the input power signal into an output power signal at the requested power level to either the electrochemical stack or the electric vehicle network. In some embodiments, the power source comprises an alternating current (AC) to direct current (DC) rectifier and a DC to DC converter or an AC to DC rectifier, a first DC to DC converter, and a second DC to DC converter, wherein the first DC to DC converter and the second DC to DC converter are connected in series. In some embodiments, the power source comprises an AC to DC rectifier, a first DC to DC converter, and a second DC to DC converter, wherein the first DC to DC converter and the second DC to DC converter are connected in parallel. In some embodiments, the power source comprises a power electronics converter comprising a configurable DC to DC converter for configuring the output power signal to the requested power level. In some embodiments, the input power signal is an AC power signal and the output power signal is a DC power signal. In still other embodiments, the hydrogen generation system further comprises a hydrogen processor providing the hydrogen to electric vehicle network in response to a request for the hydrogen from the electric vehicle network and a storage tank storing the produced hydrogen, wherein the instructions further cause the processor to provide the hydrogen to the electric vehicle network from the storage tank.

According to another embodiment, a method may include operations of receiving, at a hydrogen generating system, a request for electrical power at an electrical/hydrogen vehicle network, the request comprising a requested power level and generating, at a controller of the hydrogen generating system, one or more instructions for a power source of the hydrogen generating system for providing an output power signal at the requested power level. The method may also include the operation of transmitting, to the power source, the one or more instructions to cause the power source to convert the input power signal from an input power source in electrical communication with the hydrogen generating system into an output power signal at the requested power level to either an electrochemical stack of the hydrogen generating system or the electrical/hydrogen vehicle network. In some embodiments, the power source comprises an AC to DC rectifier and a DC to DC converter or an AC to DC rectifier, a first DC to DC converter, and a second DC to DC converter, wherein the first DC to DC converter and the second DC to DC converter are connected in series. In some embodiments, the power source comprises an AC to DC rectifier, a first DC to DC converter, and a second DC to DC converter, wherein the first DC to DC converter and the second DC to DC converter are connected in parallel. In some embodiments, the power source comprises a power electronics converter, the one or more instructions further causing the power source to select from a plurality of outputs to transmit the output power signal to either an electrochemical stack of the hydrogen generating system or the electrical/hydrogen vehicle network. In some embodiments, the method may further include receiving, at the hydrogen generating system, a request for hydrogen and controlling a hydrogen processor to provide the hydrogen to the electrical/hydrogen vehicle network in response to the request for the hydrogen.

According to yet another embodiment, a non-transitory computer-readable storage medium having computer-executable program instructions stored thereon may be included. the computer-executable program instructions may, when executed by a processor, cause a computing device to perform receiving, at a hydrogen generating system, a request for electrical power at an electrical/hydrogen vehicle network, the request comprising a requested power level and generating, by the computing device, one or more instructions for a power source of the hydrogen generating system for providing an output power signal at the requested power level. The instructions may further cause the computing device to transmit, to the power source, the one or more instructions to cause the power source to convert the input power signal from an input power source in electrical communication with the hydrogen generating system into an output power signal at the requested power level to either an electrochemical stack of the hydrogen generating system or the electrical/hydrogen vehicle network. In some embodiments, the power source comprises an AC to DC rectifier and a DC to DC converter or an AC to DC rectifier, a first DC to DC converter, and a second DC to DC converter, wherein the first DC to DC converter and the second DC to DC converter are connected in series. In some embodiments, the power source comprises an AC to DC rectifier, a first DC to DC converter, and a second DC to DC converter, wherein the first DC to DC converter and the second DC to DC converter are connected in parallel. In some embodiments, the power source comprises a power electronics converter, the one or more instructions further causing the power source to select from a plurality of outputs to transmit the output power signal to either an electrochemical stack of the hydrogen generating system or the electrical/hydrogen vehicle network.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates shows an exemplary environment for hydrogen production according to aspects of the present disclosure.

FIG. 2 illustrates a first embodiment of an ancillary electric vehicle or fuel cell electric vehicle charging and refueling system.

FIG. 3 illustrates a flowchart of a method for providing electrical power to an electrical/hydrogen vehicle network from a hydrogen generator device.

FIG. 4 illustrates a second embodiment of an ancillary electric vehicle or fuel cell electric vehicle charging and refueling system, according to an embodiment.

FIG. 5 illustrates a third embodiment of an ancillary electric vehicle or fuel cell electric vehicle charging and refueling system, according to an embodiment.

FIG. 6 illustrates a fourth embodiment of an ancillary electric vehicle or fuel cell electric vehicle charging and refueling system, according to an embodiment.

FIG. 7 illustrates an exemplary computing system which may be used in implementing embodiments of the present disclosure.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

The systems and methods described herein provide high-precision control of hydrogen generation and electricity use, thereby increasing the efficiency of the overall process. The value of the present disclosure is diverting energy resources to either an electrochemical stack or charging or refueling battery electric vehicles or fuel cell electric vehicles. As used herein, “electric vehicle” may include battery electric vehicles or fuel cell electric vehicles. In some embodiments, a hydrogen generator may include a power source that includes a rectifier for converting an alternating current input power signal to a direct current power signal. The direct current power signal may also be converted to a voltage level through a converter as an output to a vehicle network. The hydrogen generator may also produce and provide hydrogen to the vehicle network. In some implementations, the vehicle network may include one or more electrical vehicles, hydrogen fuel-based vehicles, or hybrid hydrogen/electrical vehicles. Thus, the hydrogen generator may provide both electricity and hydrogen to a vehicle network for recharging/fueling the vehicles of the network. In some implementations, the vehicle network may request electrical power and/or hydrogen from the hydrogen generator to provide fuel for the vehicles of the network.

The multi-output feature of the hydrogen generation system may provide a more efficient use of capital resources and input resources than providing energy and hydrogen to a electrical/hydrogen vehicle network. For example, a standard battery electric vehicle charging system may only be utilized 25% of the time, as power would only be transmitted to the vehicle network 214 during charging demands. In the described system, however, hydrogen can be produced during off-peak times (or at times in which electrical power is not being provided) and stored in the hydrogen storage tank for later utilization. Thus, power from the system may be diverted to the electrical/hydrogen vehicle network 214 in response to a request for electrical power, and then utilized to generate hydrogen for later charging during times in which electrical charging is not requested. In addition, the disclosed system provides for fewer energy losses during transmission, distribution, and conversion of electrical power and/or hydrogen fuel. For example, even assuming a 92-95% conversion efficiency with industry-standard electronics, excessive conversion from AC to DC or between various DC voltages by electrical power providers can compound into significant energy losses when scaled across the world. Through the use of the components of the hydrogen generation system, however, fewer conversions of the electrical power in comparison to typical electrical charging devices may improve the efficiency of providing said power, particularly in large scale applications.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

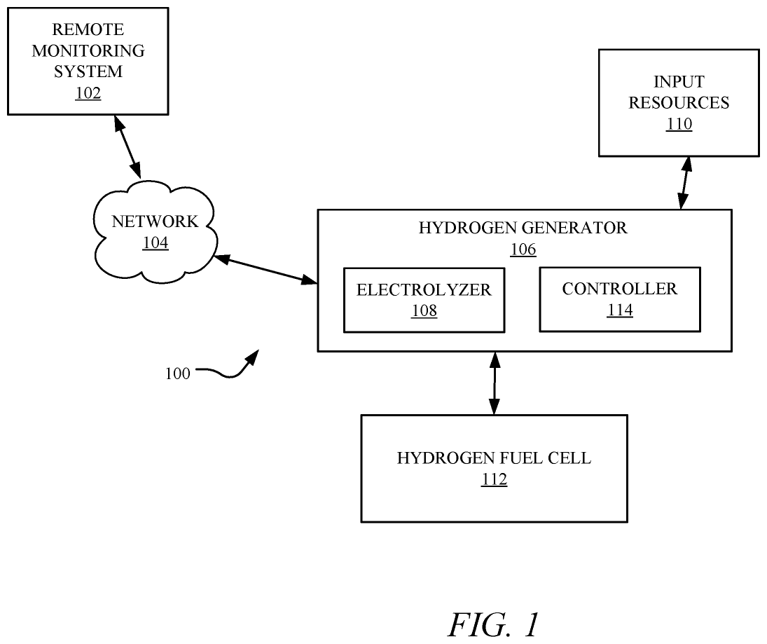

FIG. 1 shows an exemplary environment 100 for hydrogen production according to aspects of the present disclosure. The environment 100 may include more or fewer components than illustrated in FIG. 1, which is included to provide context for the operations and configurations described herein. Additional components and/or configurations of the hydrogen production environment 100 are described in greater detail below.

The environment 100 may include a hydrogen generator 106 designed and configured to generate hydrogen. The hydrogen generator 106 may include a system housed in a container, outdoor-rated cabinets, or multiple systems contained within a site. In one implementation, the hydrogen generator 106 may be a clean hydrogen facility. Such clean hydrogen facility installations are at the early stages of the industry with a significant market growth projection that may scale to much larger production capacity and higher integration adaptation to the upstream and downstream required configurations over time.

As described above, the hydrogen generator 106 generate hydrogen through electrolysis and, more particularly, an electrolyzer or electrolyzer stack 108. The electrolyzer stack 108 is the key equipment component in the hydrogen production process. The quality of the electrolyzer stack 108 determines the operational safety and stability of hydrogen production equipment. The electrolyzer equipment is comprised of various electrolytic cells, and every cell is composed of the main electrode plates, positive net, seal diaphragm gasket, and negative net. An electrolyzer stack, by comparison, comprises multiple cells connected in series in a bipolar design. The stacked bipolar electrolyzer 108 offers a technological engineering solution for the mass production of electrodeposited conducting polymer electrodes for supercapacitors

Most electrolyzers 108 include an anode and a cathode separated by an electrolyte or membrane in the presence of water. As energy, such as a direct-current (DC) power, is applied, the water molecules react at the anode to form oxygen and positively charged hydrogen ions. With the support of an electrolyzer 108, hydrogen and oxygen may be created from a pure water supply and electrical current. Hydrogen can then be utilized to power a fuel cell stack 112. In particular, hydrogen ions may flow through the electrolyte of the electrolyzer 108 to the cathode to bond with electrons and form hydrogen gas. The leftover oxygen may be released into the atmosphere or can be captured or stored to supply other industrial processes or even medical gases, in some cases. The hydrogen gas can either be stored as a compressed gas or liquefied, and since hydrogen is an energy carrier, it can be used to power such hydrogen fuel cell electric applications 112 as trains, buses, trucks, or data centers.

Electrolyzers 108 can range in size from small equipment, well-suited for modest-scale distributed hydrogen production to large-scale, central production facilities, capable of being sequenced directly to renewable or other non-greenhouse-gas-emitting forms of electricity production. In one particular implementation, the hydrogen generator 106 may be utilized to generate hydrogen for one or more hydrogen fuel cells 112 of a vehicle or vehicles.

As should be appreciated, the hydrogen generator 106 may utilize several input resources 110 for generation of hydrogen. For example, various forms of energy sources (grid electricity, natural gas, wind, solar, hydro, etc.) may be provided to the hydrogen facility for use by the components of the generator. Other input resources 110, such as water for use by the electrolyzer 108 may also be provided to the hydrogen generator 106 for producing hydrogen.

The hydrogen generator 106 may include several components in addition to the electrolyzer 108. Control over the various components, systems, programs, and/or sensors of the generator 106 may be executed through a controller 114. For example, a Supervisory Control and Data Acquisition (SCADA) control system 114 may be integrated with the hydrogen generator 106 to monitor generator conditions and/or control various aspects or parameters of the components of the generator. In one particular instance, a sensor may be associated with a pipe containing gas generated from the electrolysis process to measure the pressure within the pipe. The sensor may provide readings or measurements to the controller 114 which may, in response, adjust one or more valves within the gas piping system to adjust the pressure within the piping system. In general, any adjustable aspect or parameter of the hydrogen generator, the components within the generator, input resources 110, sensors, executable program associated with the generator, or any other aspect of the hydrogen generator 106 may be adjustable by the controller 114. In some instances, the controller 114 may also include an interface through which a generator operator may access components of the generator 106 and make one or more adjustments to the components. In another instance, the controller 114 may be configured to automatically adjust the parameters or aspects of the hydrogen generator 106 based on inputs from one or more sensors or any other source of operational data of the generator. Additional details of the controller 114 and the hydrogen generator 106 in general are discussed in more detail below.

The environment 100 may also, in some instances, include a remote monitoring system 102 that communicates with the hydrogen generator 106 through a network 104 connection. In one example, the remote monitoring system 102 may be in communication with the electrolyzer 108 to monitor one or more operational states of the electrolyzer and adjust one or more parameters of the electrolyzer accordingly. The network 104 connects the remote monitoring system 102 to one or more communication interface devices of the hydrogen generator 106 and may be configured to transmit and/or receive information between the remote monitoring system and other devices by way of one or more wired or wireless communication networks or connections. Examples of such networks or connections include, without limitation, wireline communication over serial or Ethernet in copper or fiber medium or wireless communication over USB, Wi-Fi, Bluetooth, Zigbee mesh network, or a cellular wireless network. One or more such communication interface devices may be utilized to communicate with the remote monitoring system 102 and/or the hydrogen generator 106, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

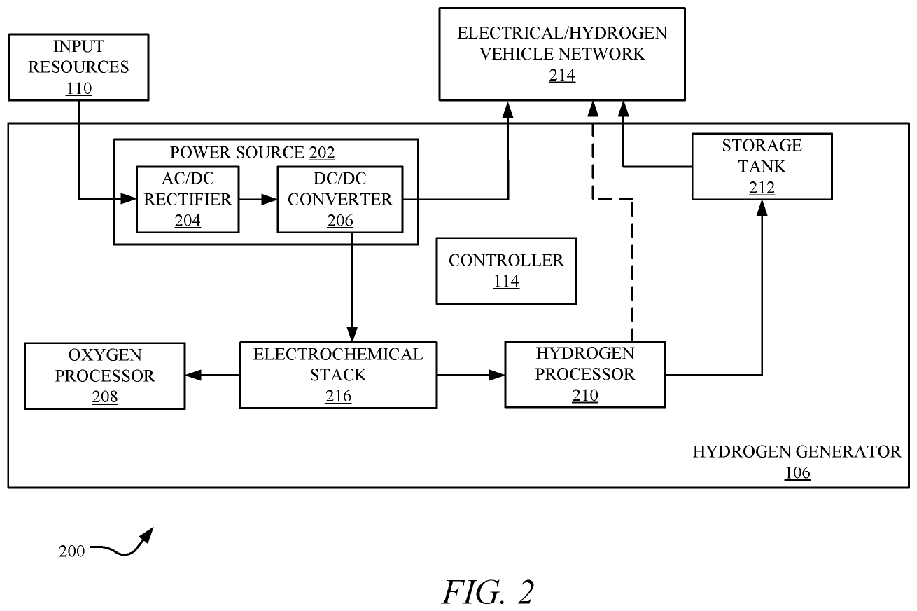

As mentioned above, the hydrogen system 100 may be utilized to provide hydrogen for a fuel cell of a hydrogen-fueled vehicle. In addition, the hydrogen system 100 may also provide electrical power for charging a battery or other energy storage device of an electrical vehicle or electrical/hydrogen hybrid vehicle. FIG. 2 is a first embodiment of an ancillary electric vehicle or fuel cell electric vehicle charging and refueling system 200 for providing energy and/or fuel to a electrical/hydrogen vehicle network. In one implementation, the system 200 may be a recharging or refueling site for one or more vehicles. The illustrated system 200 comprises a hydrogen generator 106 for hydrogen generation. The hydrogen generator 106 may be the same or similar to that described above with reference to FIG. 1. However, in this illustration, additional components of the hydrogen generator 106 is illustrated, such as an oxygen processor 208, an electrochemical stack 216 (which may include an electrolyzer 108 as discussed above), and a hydrogen processor 210. The oxygen processor 208, the electrochemical stack 216, and the hydrogen processor 210 are fluidically isolated from each other with at least one fluid connector fluidly connecting the oxygen processor and the electrochemical stack and at least one fluid connector fluidly connecting the electrochemical stack and the hydrogen processor. As further discussed below, the hydrogen generator 106 may also include a power source 202, a plurality of gas movers, a controller 114, and a storage tank 212, among other components and systems.

In some instances, the electrochemical stack 216 may include a first membrane electrode assembly (MEA), a second membrane electrode assembly (MEA), and a bipolar plate that collectively defines two complete electrochemical cells for hydrogen generation. The electrochemical stack 216 may also include a first end plate and a second end plate that may sandwich the first MEA, the second MEA, and the bipolar plate into contact with one another and direct the flow of fluids into and out of the electrochemical stack. While the electrochemical stack 216 is described as including two complete cells—a single bipolar plate and two MEAs—it should be appreciated that this is for the sake of clarity of explanation only. The electrochemical stack 216 may alternatively include any number of MEAs and bipolar plates useful for meeting the hydrogen generation demands of the system 200 while maintaining separation between pressurized hydrogen and lower pressure water and oxygen flowing through the electrochemical stack, unless otherwise specified or made clear from the context. The electrochemical stack 216 may include more than one bipolar plate, a single MEA, and/or more than two MEAs. In some embodiments, the bipolar plate may be disposed between the first end plate and the first MEA and/or between the second end plate and the second MEA, without departing from the scope of the present disclosure.

In some embodiments, the first MEA and the second MEA of the electrochemical stack 216 may be identical. For example, the first MEA may include an anode, a cathode, and a proton exchange membrane (e.g., a PEM electrolyte) therebetween. Similarly, the second MEA may include an anode, a cathode, and a proton exchange membrane therebetween. The anodes may each comprise an anode catalyst (i.e., electrode) contacting the membrane and an optional anode fluid diffusion layer. The cathodes may each comprise a cathode catalyst (i.e., electrode) contacting the membrane and an optional cathode gas diffusion layer. The anode electrode may comprise any suitable anode catalyst, such as an iridium layer. The anode fluid diffusion layer may comprise a porous material, mesh or weave, such as a porous titanium sheet or a porous carbon sheet. The cathode electrode may comprise any suitable cathode catalyst, such as a platinum layer. The cathode gas diffusion layer may comprise porous carbon. Other noble metal catalyst layers may also be used for the anode and/or cathode electrodes, including but not limited to ruthenium, rhodium, palladium, osmium, iridium, gold, and silver. The electrolyte may comprise any suitable proton exchange (e.g., hydrogen ion transport) polymer membrane.

The bipolar plate may be disposed between the cathode of the first MEA and the anode of the second MEA. In general, the bipolar plate may include a substrate, an anode gasket, and a cathode gasket. The substrate has an anode (i.e., water) side and a cathode (i.e., hydrogen) side opposite one another. The anode gasket may be fixed to the anode side of the substrate, and the cathode gasket may be fixed to the cathode side of the substrate. Such fixed positioning of the anode gasket and the cathode gasket on opposite sides of the substrate may facilitate forming two seals that are consistently placed relative to one another and relative to the first MEA and the second MEA on either side of the bipolar plate. The gaskets form a double seal around the active areas (i.e., anode (e.g., water) flow field and cathode (e.g., hydrogen) flow field) located on respective opposite sides of the bipolar plate. Further, or instead, in instances in which an electrochemical stack 216 includes an instance of an MEA between two instances of the bipolar plate, the anode gasket and the cathode gasket may form a double seal along an active area of the MEA. Thus, more generally, it shall be appreciated that the anode gasket and the cathode gasket may form a sealing engagement with one or more MEAs in an electrochemical stack to isolate flows within the electrode stack and, thus, reduce the likelihood that pressurized hydrogen may inadvertently mix with a flow of water and oxygen exiting the electrochemical stack 216 to create a combustible hydrogen-oxygen mixture in the system 200.

The substrate may be formed of any one or more of various types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during the operation of the electrochemical stack 216. The oxidation inhibitor may extend at least along the anode flow field inside the anode gasket on the anode side of the substrate. In some implementations, the oxide inhibitor may extend along the plurality of anode ports (i.e., water riser openings) which extend from the anode side to the cathode side of the substrate. The oxidation inhibitor may also be located in the anode plenums, which connect the anode ports to the anode flow field on the anode side of the substrate.

A cathode ring seal may be located around each cathode port (i.e., hydrogen riser opening) on the anode side of the substrate of the electrochemical stack 216. The cathode ring seal prevents hydrogen from leaking out into the anode flow field on the anode side of the substrate. In contrast, an anode ring seal may be located around each one or more anode ports on the cathode side of the substrate. For example, two anode ports are surrounded by a common anode ring seal to prevent water from flowing into the cathode flow field on the cathode side of the substrate.

The anode flow field may include a plurality of straight and/or curved ribs separated by flow channels oriented to direct a liquid (e.g., purified water) between at least some of the plurality of anode ports, such as may be useful for evenly distributing purified water along the anode of the second MEA. The anode gasket may circumscribe the anode flow field and the plurality of anode ports along the anode side of the substrate to limit the movement of purified water moving along the anode. The anode side of the substrate may be in sealed engagement with the anode of the second MEA via the anode gasket, such that anode channels are located therebetween. Under pressure provided by a source external to the electrochemical stack 216 (e.g., such as the pump of the oxygen processor 208), a liquid provided from the first fluid connector flows along the anode channels is directed across the anode of the second MEA, from one instance of the plurality of anode ports to another instance of the plurality of anode ports, where the liquid (e.g., remaining water and oxygen) may be directed out of the electrochemical stack through a third fluid connector.

Additionally, the substrate may include a plurality of cathode ports (i.e., hydrogen riser openings), each extending from the anode side to the cathode side of the substrate. The cathode side of the substrate may include a cathode flow field. The cathode flow field may include a plurality of straight and/or curved ribs separated by cathode flow channels oriented to direct gas (e.g., hydrogen) toward the plurality of cathode ports, which may be useful for directing pressurized hydrogen formed along with the cathode of the first MEA. Cathode plenums may be located between the cathode ports and the cathode flow field. The cathode gasket may circumscribe the cathode flow field, the cathode plenums, and the plurality of cathode ports along the cathode side of the substrate to limit movement of the pressurized hydrogen along the cathode. For example, the cathode side of the substrate may be in sealed engagement with the cathode of the first MEA via the cathode gasket, such that the cathode flow channels are defined between the cathode of the first MEA and the cathode side of the substrate. The pressure of the hydrogen formed along the cathode may move the hydrogen along at least a portion of the cathode channels and toward the cathode ports located diagonally opposite the cathode inlet port. The pressurized hydrogen may flow out of the cathode ports and out of the electrochemical stack 216 through the second fluid connector to be processed by the hydrogen circuit.

The anode gasket on the anode side of the substrate and the cathode gasket on the cathode side of the substrate may have different shapes. For example, the anode gasket may extend between the plurality of anode ports and the plurality of cathode ports on the anode side of the substrate. In other words, the anode gasket surrounds the anode ports and the anode flow field on one lateral side but leaves the cathode portions outside its circumscribed area. Therefore, the anode gasket may fluidically isolate anode flow from cathode flow in an installed position.

In contrast, the cathode gasket on the cathode side of the substrate may not extend between the plurality of anode ports and the plurality of cathode ports. In other words, the cathode gasket surrounds the anode ports, the cathode portions, and the cathode flow field. Instead, the anode ring seals isolate the anode ports from the cathode ports and the cathode flow field on the cathode side of the substrate.

In one configuration, the anode flow field and the cathode flow field may have the same shape, albeit on the opposite side of the substrate, to provide the same active area along with the first MEA and the second MEA. Thus, taken together, it shall be appreciated that the differences in shape between the anode gasket and the cathode gasket along with positioning of the anode ring seals and the same shape of the anode flow field and the cathode flow field may result in different sealed areas. These different sealed areas are complementary to one another to facilitate fluidically isolating the lower pressure flow of purified water along the anode channels from the pressurized hydrogen flowing along the cathode channels while nevertheless allowing each flow to move through the electrochemical stack 216 and ultimately exit the electrochemical stack along different channels.

In certain implementations, the cathode flow field may be shaped such that a minimum bounding rectangle of the cathode flow field is square. As used in this context, the term “minimum bounding rectangle” shall be understood to be a minimum rectangle defined by the maximum x- and y-dimensions of a cross-section of the cathode flow field. The plurality of cathode ports may include two cathode ports per substrate which are located in diagonally opposite corners from one another with respect to the minimum bounding rectangle (e.g., within the minimum bounding rectangle). The other two diagonally opposite corners lack the cathode ports. In instances in which the minimum bounding rectangle is square, the diagonal positioning of the cathode ports relative to the minimum bounding rectangle may facilitate the flow of pressurized hydrogen diagonally along the entire cathode flow field while leaving a large margin of the substrate material for strengths against the contained internal hydrogen pressure. Alternatively, the substrate may be a rectangle. The plurality of cathode ports may be positioned away from the edges of the substrate such that each one of the plurality of cathode ports is well-reinforced by the material of the substrate between the respective one of the plurality of cathode ports and the closest edge of the substrate.

Given the large pressure differential between the flow of pressurized hydrogen along the cathode channels and the flow of water and oxygen along the anode channels, the electrochemical stack 216 may include the anode fluid diffusion layer disposed in the anode channels and optionally between the anode electrode of the anode of the second MEA and the anode side (e.g., anode ribs) of the substrate. The porous material of the anode fluid diffusion layer may generally permit the flow of water and oxygen through the anode channels without a substantial increase in flow restriction through the anode channels while providing structural support on the anode side of the substrate to resist collapse that may result from the pressure difference on opposite sides of the substrate. It shall be understood, however, the that porous material may be disposed inside all of the anode channels in certain implementations.

Having described various features of the electrochemical stack 216, attention is now directed to a description of the operation of the electrochemical stack to form pressurized hydrogen with water and electricity as inputs. In particular, an electric field E (i.e., voltage) may be applied across the electrochemical stack 216 (i.e., between the end plates) from the power source 202. The bipolar plate may electrically connect the first MEA and the second MEA in series with one another such that electrolysis may take place at the first MEA and the second MEA to form a flow of pressurized hydrogen that is fluidically isolated from lower pressure water and oxygen, except for proton exchange occurring through the proton exchange.

Purified water (not shown) may be introduced into the electrochemical stack 216 via a fluid connection between the oxygen processor and electrochemical stack. Within the electrochemical stack 216, the purified water may flow along an intake channel to direct the purified water to the anode of the first MEA and the anode of the second MEA. With the electric field E applied across the anode and the cathode of the first MEA, the purified water may break down along the anode into protons (W) and oxygen. The protons (W) may move through the proton exchange membrane from the anode to the cathode. At the cathode, the protons (W) may combine to form pressurized hydrogen along the cathode. Through an analogous process, pressurized hydrogen may also be formed along the cathode of the second MEA. The flows of pressurized hydrogen formed by each of the first MEA and the second MEA may combine and flow out of the electrochemical stack 216 via two hydrogen exhaust channels that extends through the bipolar plate, among other components, to ultimately direct the pressurized hydrogen toward the hydrogen processor 210. The flows of oxygen and water along the first anode and the second anode may combine and flow out of the electrochemical stack 216 via the outlet anode ports and an outlet channel to direct this stream of water and oxygen toward the oxygen processor 208.

Some implementations of the hydrogen generator 106 may include a plurality of gas movers that include one or more of various types of fans (e.g., purge fans), blowers, or compressors. In some implementations, each one of the plurality of gas movers may be disposed within the electrochemical stack 216 or, alternatively, each one of the plurality of gas movers may be mounted externally to the electrochemical stack (e.g., to the roof or sidewall of the cabinet) to reduce the potential for heat or sparks to act as an inadvertent ignition source for contents of the generator.

As described above, the hydrogen generator 106 may also include a controller 114, which may be in electrical communication at least with one or more components of the generator. In general, the controller 114 may include one or more processors and a non-transitory computer-readable storage medium having stored thereon instructions for causing the one or more processors to control one or more of the startup, operation, or shutdown of any one or more of various aspects of the system 200 to facilitate safe and efficient operation. For example, the controller 114 may be in electrical communication at least with the electrochemical stack 216 and the power source 202. Continuing with this example, the controller 114 may interrupt power to the electrochemical stack 216 if an anomalous condition is detected. Further, or instead, the controller 114 may control the power to the electrochemical stack 216 after a startup protocol to reduce the likelihood of igniting a hydrogen-containing mixture in the electrochemical stack.

In certain implementations, the controller 114 may further, or instead, monitor one or more ambient conditions of the hydrogen generator 106 to facilitate taking one or more remedial actions before an anomalous condition results in damage to the system 200 and/or to an area near the system. In one particular example, given the potential damage that may be caused by the presence of an ignitable hydrogen-containing mixture within the electrochemical stack 216, the system 200 may include a plurality of gas sensors (referred to collectively as the plurality of gas sensors and individually as the first gas sensor, second gas sensor, or third gas sensor). Each of the plurality of gas sensors may include any one or more of various types of hydrogen sensors, such as one or more optical fiber sensors, electrochemical hydrogen sensors, thin-film sensors, and the like. Each one of the plurality of gas sensors may be calibrated to detect hydrogen concentration levels below the ignition limit of hydrogen to facilitate taking remedial action before an ignition event can occur. Toward this end, the controller 114 may be in electrical communication with each one of the plurality of gas sensors. The non-transitory computer-readable storage media of the controller 114 may have stored thereon instructions for causing one or more processors of the controller to interrupt electrical communication between the power source 202 and equipment in the electrochemical stack 216 based on a signal, received from one or more of the plurality of gas sensors and indicative of a dangerous hydrogen concentration. Additionally, or alternatively, the signal received from one or more of the plurality of gas sensors may indicate a rapid increase in hydrogen concentration. In general, the controller 114 may respond to any measured or detected condition of the hydrogen generator 106 and control one or more components of the generator accordingly.

In some implementations, the hydrogen generator 106 may be coupled to an external water source (e.g., water pipe, not shown) to receive a water supply suitable for meeting the demands of the electrochemical stack 216. The connection between the hydrogen generator 106 and the external water source may facilitate connection of the system 200 to an industrial water supply and, in some instances, to reduce the likelihood of damaging equipment in the event of a leak in the connection between the external water source. In still other implementations, the hydrogen generator 106 may include a recirculation circuit to receive an exit flow of water and oxygen from the anode portion of the electrochemical stack 216.

One or more of various gas-liquid separators suitable for separating oxygen from excess water may be included in the oxygen processor 208. For example, the oxygen processor 208 may include a dryer, a condenser, or another device that separates oxygen from excess water through gravity. The excess water may settle along a bottom portion of the oxygen processor 208, and oxygen is collecting along the top. The oxygen collected by the oxygen processor 208 may be directed out of the hydrogen generator 106.

Further, embodiments may include a hydrogen processor 210, which may include a hydrogen circuit, a dryer, and a hydrogen pump. In use, a product stream consisting of hydrogen and water (e.g., water vapor) may move from the anode side of the electrochemical stack 216 to the inlet portion of a dryer. The dryer may be, for example, pressure swing adsorption (PSA), a temperature swing adsorption (TSA) system, or a hybrid PSA-TSA system. The dryer may include one or more beds of a water-adsorbent material, such as activated carbon, silica, zeolite, or alumina. As the product mixture consisting of hydrogen and water moves through from the inlet portion to an outlet portion of the dryer, at least a portion of the water may be removed from the product mixture through adsorption of either water or hydrogen in the bed of water-adsorbent material.

The hydrogen pump may be, for example, an electrochemical pump. As used in this context, an “electrochemical pump” shall be understood to include a proton exchange membrane (i.e., a PEM electrolyte) disposed between an anode and a cathode. The hydrogen pump may generate protons moveable from the anode through the proton exchange membrane to the cathode to form pressurized hydrogen. Thus, such an electrochemical pump may be particularly useful for recirculating hydrogen within the hydrogen circuit at least because the electrochemical pumping provided by the electrochemical pump separates hydrogen from water in the mixture delivered to the hydrogen pump via the pump conduit while also pressurizing the separated hydrogen to facilitate moving the pressurized hydrogen to the inlet portion of the dryer.

Some embodiments may include storage tank 212, which may include a plurality of hydrogen storage tanks to contain the hydrogen created from the hydrogen processor 210. The storage tank 212 may be used to store excess hydrogen created by the hydrogen processor 210 to be used or shipped to users at a later time. In some instances, the produced hydrogen may not be stored in a storage tank but may instead be directly provided to an end user or to a storage tank external to the hydrogen generator. The storage tank 212 may be used to contain hydrogen until shipped to users, such as electrical/hydrogen vehicle networks 214 and/or industrial outputs, among other users.

As mentioned above, the hydrogen generated by the generator 106 may be provided to fuel one or more hydrogen fuel cells, such as in vehicles containing hydrogen fuel cells. Thus, system 200 may further include an electric vehicle network 140, which connects to the hydrogen generator, such as through the storage tank 212 or through a direct connection to the generator, to receive hydrogen. The electrical/hydrogen vehicle network 214 may also be in communication with the hydrogen generator 106, such as the controller 114, to send requirements of the vehicles of the network or to otherwise request generated hydrogen. The electrical/hydrogen vehicle network 214 may maintain the requirements to properly fuel the vehicles of the network by sending the requirements to the hydrogen generator 106. In addition and as explained in more detail below, the electrical/hydrogen vehicle network 214 may also communicate with the hydrogen generator 106 to request electrical energy from the power source 202 of the generator.

To request electrical power from the hydrogen generator 106, the electrical/hydrogen vehicle network 214 may determine the electrical requirements of the vehicles or hydrogen requirements of the vehicles of the network and transmit a notification to the controller 114 of the generator to attempt to maintain the requirements needed by the vehicles. For example, the requirements may be a voltage needed to properly charge an electrochemical device, such as a battery, of one or more electrical vehicles. The requirements may also include a required hydrogen to properly charge a hydrogen fuel cell of one or more vehicles. The electrical/hydrogen vehicle network 214 may send the requirement data to the hydrogen generator 106 or any other system in communication with hydrogen generator to request the electrical power and/or hydrogen generation.

The electrical/hydrogen vehicle network 214 may therefore include the one or more vehicles that are powered by electricity, hydrogen, or both. In one implementation, the electrical/hydrogen vehicle network 214 may be a vehicle refueling center with multiple charging stations or ports for electrical and/or hydrogen-based vehicles. In another implementation, the electrical/hydrogen vehicle network 214 may be a single charging station to provide either electric charging, hydrogen charging, or both.

Regardless, the electric vehicles of the electrical/hydrogen vehicle network 214 may have a battery or other electrochemical device and an electric motor. The fuel cell vehicle or fuel cell electric vehicle may be an electric vehicle that uses a fuel cell, sometimes in combination with a small battery or supercapacitor, to power its on-board electric motor. As discussed, the vehicles of the electrical/hydrogen vehicle network 214 may be charged or powered by the power source 202 of the hydrogen generator 106 or by the hydrogen generated by the generator.

In some examples, the vehicles of the electrical/hydrogen vehicle network 214 may include fuel cell electric vehicle powertrains for long-haul buses and trucks (i.e., electric vehicles powered by hydrogen). Hydrogen is stored in a fuel tank and then routed to a fuel cell where it reacts with oxygen to produce electricity that powers the vehicle, and water (the only emission other than hot air) has more promise than EV battery-based systems. The initial use of hydrogen for transport is municipal bus and truck fleets, already on the road in many parts of the world. These are centrally fueled, avoiding the need for a retail network, and onboard hydrogen storage is less of a problem than cars. Buses typically use two fuel cell stacks of about 100 kW plus a small traction battery topped up by regenerative braking. They carry 30 to 50 kg of compressed hydrogen stored in polymer-lined, fiber-wound pressure tanks at 350 bar (35 MPa). Newer fuel cell buses use only 8 to 9 kg of hydrogen per 100 km, which compares well in energy efficiency with diesel buses. In addition, many such vehicles include a battery for shorter distances. The batteries of such vehicles may store electrical energy for driving the powertrain of the vehicle. However, battery devices may be quite heavy and can not often store enough electrical energy for long distances. Thus, some of the vehicles of the electrical/hydrogen vehicle network 214 may include both hydrogen fuel cells and electrical cells for operating the vehicles.

The hydrogen for charging a fuel cell of a vehicle may be generated by the electrochemical stack 216 discussed above and provided to the electrical/hydrogen vehicle network 214. In addition, electrical power may be provided to the electrical/hydrogen vehicle network 214 by the power source 202 of the hydrogen generator 106. In particular, the power source 202 of the hydrogen generator 106 may receive power from an input resource 110, such as a local power grid, a solar power array, a wind turbine, energy storage, conventional energy resources such as nuclear power stations, gas power plants, etc. The power from the input resource 110 may be provided to the power source 202 of the hydrogen generator 106, and more particularly an alternate current/direct current (AC/DC) rectifier 204. The AC/DC rectifier 204 converts an oscillating two-directional AC power signal into a single-directional DC power signal.

The rectified power signal may thus be provided to a DC/DC converter 206 of the power source 202, an electronic circuit or electromechanical device that converts a source of direct current (DC) from one voltage level to another. For example, the DC/DC converter 206 may increase the power received from the rectifier 204 to power the electrochemical stack 216. In another example, the converter 206 may step down the power signal to a lower value for use by the stack 216. The DC/DC converter 206 may switch its output to one of two outputs, the first output to power the electrochemical stack 216 and the second output to charge the vehicles of the electrical/hydrogen vehicle network 214. Thus, the DC/DC converter 206 may receive a source of DC power from the AC/DC rectifier 204 and convert the voltage level necessary to power the electrochemical stack 216 and/or convert the voltage level necessary to power the vehicles of the electrical/hydrogen vehicle network 214.

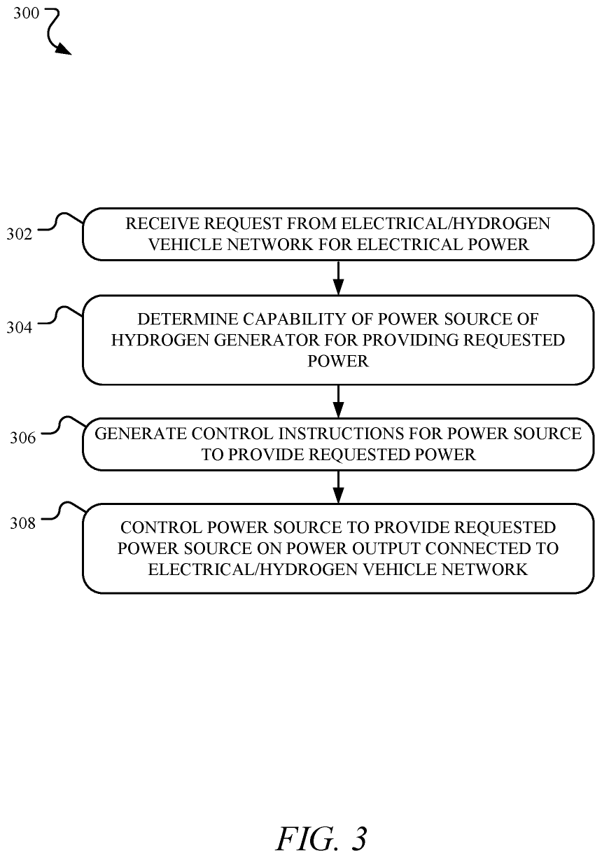

In this manner, the power source 202 may be configurable or otherwise controllable to provide power to either the electrochemical stack 216 or the electrical/hydrogen vehicle network 214 or both systems. The control of the power source 202 to provide the power to either or both of the systems is described below with reference to the flowchart of method 300 of FIG. 3. At step 302 of method 300, a request for electrical power by the electrical/hydrogen vehicle network 214 may be received at the controller 114. The electrical/hydrogen vehicle network 214 may generate such a request to power any number of electric or hybrid vehicles in communication with the electrical/hydrogen vehicle network or otherwise associated with the electrical/hydrogen vehicle network. For example, the request may be transmitted to the controller 114 in response to an electric vehicle plugging into a charger at the electrical/hydrogen vehicle network 214. The request may include a value of requested power to meet the needs of the vehicles of the electrical/hydrogen vehicle network 214. In some instances, the request may be transmitted to the controller 114 through any communication method discussed herein or hereafter developed.

At step 304, a capability of the power source 202 to provide the requested power to the electrical/hydrogen vehicle network 214 may be determined. For example, the power source 202 may be limited on the amount of power that is available based on a limit imposed by the input resources 110. In another example, the electrochemical stack 216 may be given priority to available power such that the electrical/hydrogen vehicle network 214 may receive any remaining power not diverted to the electrical/hydrogen vehicle network. In another example, the electrical/hydrogen vehicle network 214 may be given priority over the electrochemical stack 216. Such control of the power source 202 may be executed through one or more power source control rules or instructions executed by the controller. As the controller 114 may control the operation of the electrochemical stack 216 and the amount of power provided to the stack by the power source 202, the controller may determine an amount of power to provide to the electrical/hydrogen vehicle network 214 in response to the received request.

At step 306, one or more control instructions may be generated for the power source 202 to provide the requested power to the electrical/hydrogen vehicle network 214. For example, the power source 202 may include a switch to alternate providing power from the DC/DC converter 206 to either the electrochemical stack 216 or the electrical/hydrogen vehicle network 214. An instruction to toggle the switch in one direction or the other may be generated by the controller 114 and provided to the switch. In another example, the DC/DC converter 206 may split a generated power signal between the electrochemical stack 216 and the electrical/hydrogen vehicle network 214. In general, any controllable component of the power source 202 may be associated with a control instruction to provide a requested power to the electrical/hydrogen vehicle network 214 based on the received request. At step 308, the one or more generated control instructions may be transmitted or otherwise provided to the power source 202 to direct a power signal to the electrical/hydrogen vehicle network 214 to provide the requested power or a portion of the requested power to the vehicle network.

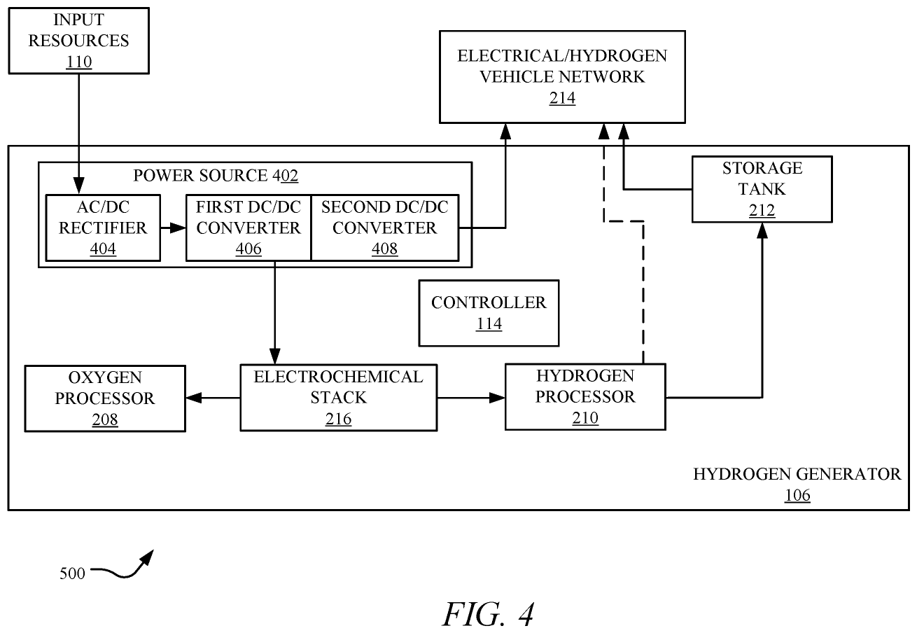

FIG. 4 illustrates a second embodiment of an ancillary electric vehicle or fuel cell electric vehicle charging and refueling system 400, according to an embodiment. The system 400 of FIG. 4 includes similar or the same components as the systems discussed above with relation to FIG. 1 and FIG. 2. For example, the system 400 may include hydrogen generator 106 comprising an oxygen processor 208, an electrochemical stack 216, a hydrogen processor 210, a storage tank 212, and/or a controller 114. In addition, an electrical/hydrogen vehicle network 214 may receive outputs from the hydrogen generator 106, such as hydrogen from the storage tank 212 or the hydrogen processor 210. In addition, input resources 110, such as a power signal, may be provided to a power source 402, as also discussed above.

In this system 400, the power source 402 may include an AC/DC rectifier 404 as discussed above, a first DC/DC converter 406, and a second DC/DC converter 408. The first DC/DC converter 406 and the second DC/DC converter 408 may be connected in a series connection. The AC/DC rectifier 404 may convert the AC power signal from the input resources 110 to a DC power signal, as described above. The first DC/DC converter 406 may receive a source of DC power from the AC/DC rectifier 404 and convert the voltage level necessary to power the electrochemical stack 216. In some implementations, the first DC/DC converter 406 may be configurable by the controller 114 to adjust the power provided to the electrochemical stack 216 by the power source 202. The second DC/DC converter 408 may be connected in series with the first DC/DC converter 406 and may receive a source of DC power from the first DC/DC converter and convert the voltage level necessary to power the electrical/hydrogen vehicle network 214. In some implementations, the second DC/DC converter 408 may be configurable by the controller 114 to adjust the power provided to the electrical/hydrogen vehicle network 214 by the power source 202.

As compared to the embodiment shown in FIG. 2, the embodiment of FIG. 4 employs a plurality of output stages for the power source 402. In particular, the power source 402 may include a first output stage at the first DC/DC converter 406 and a second output stage at the second DC/DC converter 408. To control the output of the power source 402, the controller 114 may select the output of the power source 402 to power either the electrochemical stack 216 or the electrical/hydrogen vehicle network 214, or both. Further, each output stage of the power source 402 may provide different power levels to the electrochemical stack 216 and/or the electrical/hydrogen vehicle network 214. In some implementations, the controller 114 may receive a request from the electrical/hydrogen vehicle network 214 for a power signal while also controlling the power to the electrochemical stack 216 independently from the power provided to the electrical/hydrogen vehicle network.

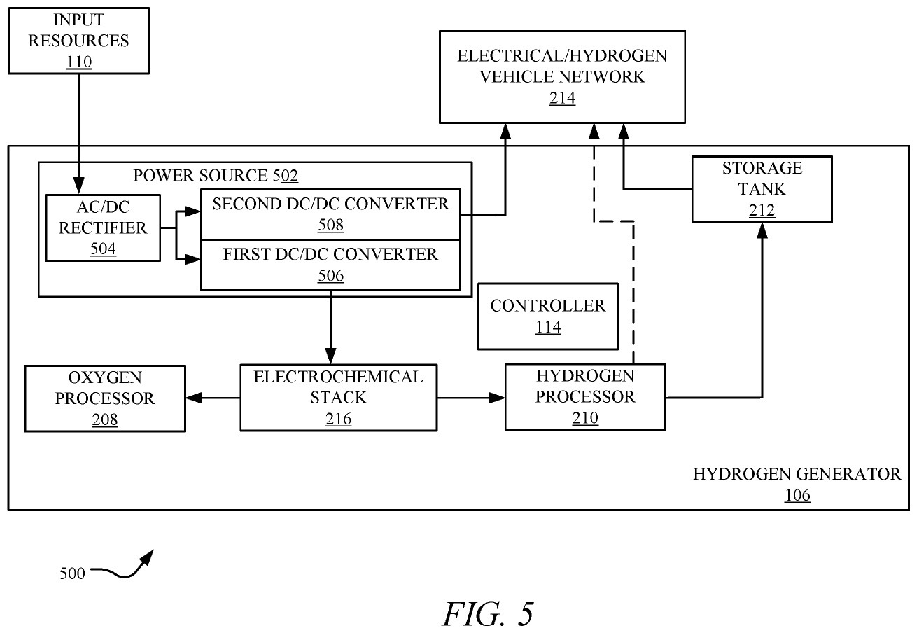

FIG. 5 illustrates a third embodiment of an ancillary electric vehicle or fuel cell electric vehicle charging and refueling system 500, according to an embodiment. The system 500 of FIG. 5 includes similar or the same components as the systems discussed above. For example, the system 500 may include hydrogen generator 106 comprising an oxygen processor 208, an electrochemical stack 216, a hydrogen processor 210, a storage tank 212, and/or a controller 114. In addition, an electrical/hydrogen vehicle network 214 may receive outputs from the hydrogen generator 106, such as hydrogen from the storage tank 212 or the hydrogen processor 210. In addition, input resources 110, such as a power signal, may be provided to a power source 502, as also discussed above.

In this system 500, the power source 502 may include an AC/DC rectifier 504 as discussed above, a first DC/DC converter 506, and a second DC/DC converter 508. The first DC/DC converter 506 and the second DC/DC converter 508 may be connected in a parallel connection. The AC/DC rectifier 404 may therefore convert the AC power signal from the input resources 110 to a DC power signal and provide an output DC signal to both the first DC/DC converter 506 and a second DC/DC converter 508. Both the first DC/DC converter 406 and the second DC/DC converter 408 may receive a source of DC power from the AC/DC rectifier 404 and convert the voltage level necessary to power the electrochemical stack 216 or the electrical/hydrogen vehicle network 214, respectively. In some implementations, the first DC/DC converter 506 and/or the second DC/DC converter 508 may be configurable by the controller 114 to adjust the power provided to the electrochemical stack 216 or the electrical/hydrogen vehicle network 214 by the power source 202.

As compared to the embodiment shown in FIG. 4, the embodiment of FIG. 5 employs a plurality of output stages for the power source 502 through the DC converters connected in parallel. In this orientation, the power output provided by the second DC/DC converter 508 may not be dependent upon the output of the first DC/DC converter 506. Rather, each converter 506, 508 may operate independently to provide power to the respective systems or components. To control the output of the power source 402, the controller 114 may select the outputs of the power source 402 to power either the electrochemical stack 216 or the electrical/hydrogen vehicle network 214 and adjust the operation of the corresponding DC/DC converter. In some implementations, each output stage of the power source 402 may provide different power levels to the electrochemical stack 216 and/or the electrical/hydrogen vehicle network 214.

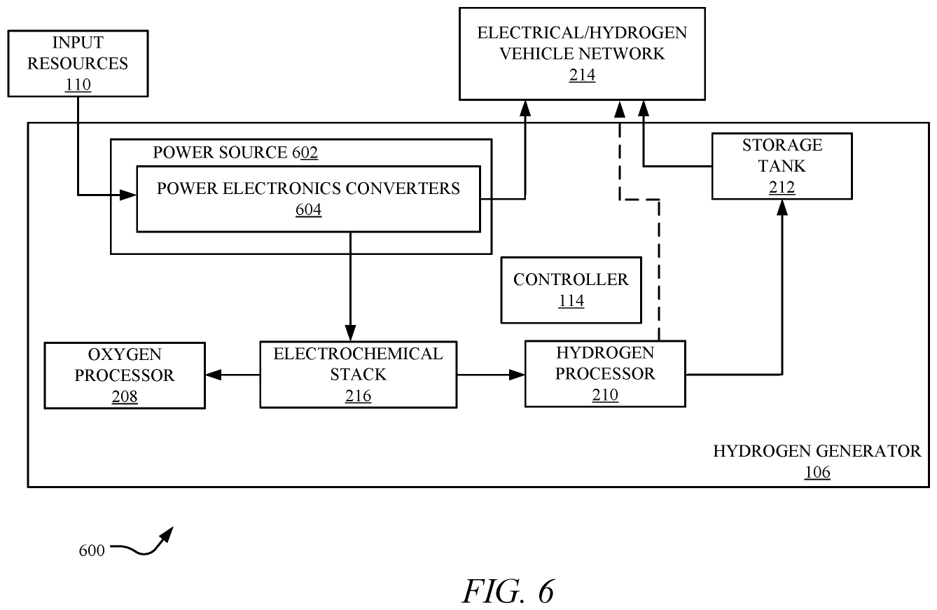

FIG. 6 illustrates yet another embodiment of an ancillary electric vehicle or fuel cell electric vehicle charging and refueling system 600, according to an embodiment. The system 600 of FIG. 6 includes similar or the same components as the systems discussed above. For example, the system 600 may include hydrogen generator 106 comprising an oxygen processor 208, an electrochemical stack 216, a hydrogen processor 210, a storage tank 212, and/or a controller 114. In addition, an electrical/hydrogen vehicle network 214 may receive outputs from the hydrogen generator 106, such as hydrogen from the storage tank 212 or the hydrogen processor 210. In addition, input resources 110, such as a power signal, may be provided to a power source 602, as also discussed above.

In this system 600, the power source 602 may include power electronics converters 604, which may receive AC energy resources and/or DC energy from the input resources 110. For example, AC energy resources may be a power grid, wind turbines, solar farms, energy storage, conventional energy resources such as nuclear power stations, gas power plants, etc. DC energy resources may be wind turbines, solar photovoltaic arrays, energy stores, DC power grids, etc. The power electronics converter 604 of the power source 602 may include an AC/DC rectifier and one or more DC to DC converters, similar to those components as discussed above. For example, an AC/DC rectifier of the power electronics converters 604 may convert an oscillating two-directional AC into a single-directional DC signal. The DC/DC converter(s) of the power electronic converters 604 may convert a voltage level of an input DC signal to another voltage level.

During operation, the power electronics converters 604 may receive an AC energy resource and convert the AC power signal to a DC power signal through the rectifier and convert the DC voltage level of the DC power signal to a requested or determined voltage to power the electrochemical stack 216. The power electronics converters 604 may also receive a DC energy resource and convert the voltage level through the DC/DC converter(s) to convert the DC voltage level to the necessary voltage to power the electrochemical stack 216. As such, the power electronics converters 604 provides for flexibility in converting either an AC input power signal or a DC input power signal to the requested power signal for the electrochemical stack 216. In a similar manner, the power electronics converters 604 may convert either an AC input power signal or a DC input power signal to the necessary voltage to power the electric/hydrogen vehicle network 214, such as to power one or more electric vehicles connected to the network. Thus, the power electronics converter 448 allows both diverted outputs (i.e., battery electric vehicle charging and fuel cell charging) to be made available as an ancillary service. As with the other systems discussed above, the hydrogen generator 106 may also provide generated hydrogen to the electric/hydrogen vehicle network 214 and/or to any other user or system.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present systems and methods, which, as a matter of language, might be said to fall therebetween.

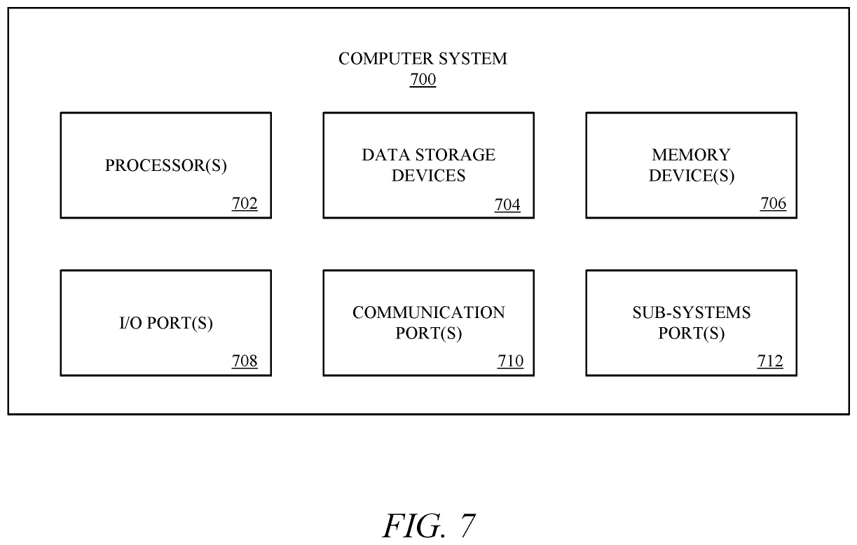

Referring to FIG. 7, a detailed description of an example computing system 700 having one or more computing units that may implement various systems and methods discussed herein is provided. The computing system 700 may be part of a controller 114, may be in operable communication with various implementation discussed herein, may run various operations related to the method discussed herein, and may be part of overall systems discussed herein. The computing system 700 may be applicable to, for example, the controller 114 discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 700 may be a computing system that is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7. Similarly, in various implementations, various elements disclosed in the system may or not be included in any given implementation.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 704, stored on the memory device(s) 706, and/or communicated via one or more of the ports 708-712, thereby transforming the computer system 700 in FIG. 7 to a special purpose machine for implementing the operations described herein.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700. The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. In some examples, such inputs may be distinct from the various system and method discussed with regard to the preceding figures. Similarly, the output devices may convert electrical signals received from computing system 700 via the I/O port 708 into signals that may be sensed or used by the various methods and system discussed herein. The input device may be an alphanumeric input device, including alphanumeric and other keys for communicating information and/or command selections to the processor 702 via the I/O port 708.

The environment transducer devices convert one form of energy or signal into another for input into or output from the computing system 700 via the I/O port 708. For example, an electrical signal generated within the computing system 700 may be converted to another type of signal, and/or vice-versa. In one implementation, the environment transducer devices sense characteristics or aspects of an environment local to or remote from the computing device 700.

In one implementation, a communication port 710 may be connected to a network by way of which the computer system 700 may receive network data useful in executing the methods and systems set out herein as well as transmitting information and network configuration changes determined thereby. The communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (4G)) network, or over another communication means.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Various embodiments of the disclosure have been discussed in detail. While specific implementations are discussed, it should be understood that this is done for illustration purposes only. A person skilled in the relevant art will recognize that other components and configurations may be used without parting from the spirit and scope of the disclosure. Thus, the description and drawings herein are illustrative and are not to be construed as limiting. Numerous specific details are described to provide a thorough understanding of the disclosure. However, in certain instances, well-known or conventional details have not been described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Thus, references to one or an embodiment in the present disclosure can be references to the same embodiment or any embodiment; and such references mean at least one of the embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

What is claimed is:

1. A system for ancillary electric vehicle or fuel cell electric vehicle charging and refueling, the system comprising:
a hydrogen generation system in communication with an input power source, the hydrogen generation system comprising:
an electrochemical stack for producing hydrogen;
a power source receiving an input power signal from the input power source and in electrical communication with an electric vehicle network and the electrochemical stack; and
a controller comprising a processor and a non-transitory computer-readable medium encoded with instructions, which when executed by the processor, cause the processor to:
receive a request for an output power signal comprising a requested power level; and
control the power source to convert the input power signal into an output power signal at the requested power level to either the electrochemical stack or the electric vehicle network.

2. The system of claim 1, wherein the power source comprises an alternating current (AC) to direct current (DC) rectifier and a DC to DC converter.

3. The system of claim 1, wherein the power source comprises an AC to DC rectifier, a first DC to DC converter, and a second DC to DC converter, wherein the first DC to DC converter and the second DC to DC converter are connected in series.

4. The system of claim 1, wherein the power source comprises an AC to DC rectifier, a first DC to DC converter, and a second DC to DC converter, wherein the first DC to DC converter and the second DC to DC converter are connected in parallel.

5. The system of claim 1, wherein the power source comprises a power electronics converter.

6. The system of claim 5, wherein the power electronics converter comprises a configurable DC to DC converter for configuring the output power signal to the requested power level.

7. The system of claim 1, wherein the input power signal is an AC power signal and the output power signal is a DC power signal.

8. The system of claim 1, wherein the hydrogen generation system further comprises:
a hydrogen processor providing the hydrogen to electric vehicle network in response to a request for the hydrogen from the electric vehicle network.

9. The system of claim 7, wherein the hydrogen generation system further comprises:
a storage tank storing the produced hydrogen, wherein the instructions further cause the processor to provide the hydrogen to the electric vehicle network from the storage tank.

10. A method comprising:
receiving, at a hydrogen generating system, a request for electrical power at an electrical/hydrogen vehicle network, the request comprising a requested power level;
generating, at a controller of the hydrogen generating system, one or more instructions for a power source of the hydrogen generating system for providing an output power signal at the requested power level; and
transmitting, to the power source, the one or more instructions to cause the power source to:
convert an input power signal from an input power source in electrical communication with the hydrogen generating system into an output power signal at the requested power level to either an electrochemical stack of the hydrogen generating system or the electrical/hydrogen vehicle network.

11. The method of claim 10, wherein the power source comprises an AC to DC rectifier and a DC to DC converter.

12. The method of claim 10, wherein the power source comprises an AC to DC rectifier, a first DC to DC converter, and a second DC to DC converter, wherein the first DC to DC converter and the second DC to DC converter are connected in series.

13. The method of claim 10, wherein the power source comprises an AC to DC rectifier, a first DC to DC converter, and a second DC to DC converter, wherein the first DC to DC converter and the second DC to DC converter are connected in parallel.

14. The method of claim 10, wherein the power source comprises a power electronics converter.

15. The method of claim 10 wherein the one or more instructions further cause the power source to select from a plurality of outputs to transmit the output power signal to either an electrochemical stack of the hydrogen generating system or the electrical/hydrogen vehicle network.

16. The method of claim 10, further comprising:
receiving, at the hydrogen generating system, a request for hydrogen; and
controlling a hydrogen processor to provide the hydrogen to the electrical/hydrogen vehicle network in response to the request for the hydrogen.

17. A non-transitory computer-readable storage medium having computer-executable program instructions stored thereon that when executed by a processor, cause a computing device to perform:
receiving, at a hydrogen generating system, a request for electrical power at an electrical/hydrogen vehicle network, the request comprising a requested power level;
generating, by the computing device, one or more instructions for a power source of the hydrogen generating system for providing an output power signal at the requested power level; and
transmitting, to the power source, the one or more instructions to cause the power source to:
convert an input power signal from an input power source in electrical communication with the hydrogen generating system into an output power signal at the requested power level to either an electrochemical stack of the hydrogen generating system or the electrical/hydrogen vehicle network.

18. The non-transitory computer-readable storage medium of claim 17, wherein the power source comprises an AC to DC rectifier and a first DC to DC converter, and a second DC to DC converter, wherein the first DC to DC converter and the second DC to DC converter are connected in series.

19. The non-transitory computer-readable storage medium of claim 17, wherein the power source comprises an AC to DC rectifier, a first DC to DC converter, and a second DC to DC converter, wherein the first DC to DC converter and the second DC to DC converter are connected in parallel.

20. The non-transitory computer-readable storage medium of claim 17, wherein the power source comprises a power electronics converter.
